(19) United States
(12) Patent Application Publication
(10) Pub. No.: US 2005/0269158 A1
(43) Pub. Date: Dec. 8, 2005

(54) System for suspending structures from trees

(76) Inventor: Robert H. Fulton, North Delta (CA)

Correspondence Address: KOLISCH HARTWELL, P.C., 520 S.W. YAMHILL STREET, SUITE 200, PORTLAND, OR, 97204, US

(21) Appl. No.: 10/859,699

(22) Filed: Jun. 2, 2004

(51) Int. Cl. A01M 31/00

(52) U.S. Cl. 182/187

(57) ABSTRACT

A system for suspending a structure from a tree comprising a collection of primary tension members interwoven to define a sleeve adapted to grip a portion of the tree, and at least one hanger assembly extending from the sleeve having an end connectable to the structure to be suspended. The suspension system accommodates different sizes of tree trunks and branches, and changes in diameter of the tree. The system of the present invention is mountable to a tree without damaging the tree or impeding its growth. The system accommodates the natural flexing of the tree due to wind while reliably retaining any supported structure suspended above the ground.

### FIELD OF THE INVENTION

This invention relates generally to suspended structures, and, more particularly to a construction system for suspending structures from trees. The present invention also find application for providing support for damaged or weak trees or for Forestry functions where it is necessary to fasten and apply load to a tree without damaging the branches or trunk.

### BACKGROUND OF THE INVENTION

Trees, by virtue of having a trunk or large branches of generally cylindrical configuration, provide natural columns or posts for supporting structures, particularly elevated structures. Tree houses are probably the most common form of elevated structure supported by trees.

Examples of prior patents directed to tree houses are as follows.

U.S. Pat. No. 5,522,186 to Jarman discloses a tree-supported house structure including a plurality of annular members for supporting cables. The annular members are mounted to the tree via fasteners 32 that are driven into the tree trunk.

U.S. Pat. No. 4,056,902 to Ziegler, Jr. discloses a tree-supported house kit in which the internal framework of the tree-house is directly attached to the tree by fasteners which extend into the trunk.

Other structure intended for use with trees are described in the following patents.

U.S. Pat. No. 4,744,537 to Buckley discloses a hanger bracket that is suitable for attachment to a tree with damaging or marking the tree. The bracket relies on upper and lower encircling cords to support a suspension arm, however, the device is not intended to support substantial loads.

Beauchemin in U.S. Pat. No. 6,196,511 discloses a portable hook hanging system for attachment to vertical objects including trees. Once again, the system is not suitable for carrying large, sustained loads.

U.S. Pat. No. 2,754,944 to Petersen discloses a band-fitting for the attachment of guy wires to wood poles.

In recent years, with more emphasis being placed on preserving the environment, it is preferable when designing systems that interface with living trees to minimize or eliminate any damage to the trees. A recent trend has been the installation of platforms and walkways extending between living trees to allow scientists to study the niche ecosystem of this region above the forest floor within the branches and foliage of the trees. The public is also interested in exploring this hitherto inaccessible area. However, existing construction systems and techniques that interface with trees are generally not environmentally friendly to the trees and involve driving fasteners through the tree bark into the interior of the tree as described in the tree house patents above. Besides physically damaging the tree, perforating the bark provides a pathway for fungal or insect attach. Systems that rely on piercing fasteners for mounting to a tree do not accommodate growth of the tree and are at odds with the environmentally friendly approach prevalent today.

### SUMMARY OF THE INVENTION

To address the problem of providing an environmentally friendly method for suspending structures from trees or for supporting and bracing trees, we have developed a novel system that readily accommodates different sizes of tree trunks and branches, and changes in diameter of the tree. The system of the present invention is mountable to a tree without damaging the tree or impeding its growth. The system accommodates the natural flexing of the tree due to wind while reliably retaining any supported structure suspended above the ground.

Accordingly, the present invention provides a system for suspending a structure from a tree comprising:
a collection of primary tension members interwoven to define a sleeve adapted to grip a portion of the tree; and
at least one hanger assembly extending from the sleeve having an end connectable to the structure to be suspended.

The present invention also provides a tree structure comprising:
a tree having a region to act as an anchor;
at least one array of primary tension members interwoven to define a sleeve adapted to surround and engage the region of the tree;
hanger assemblies extending from the sleeve; and
at least one platform structure supported by the hanger assemblies.

### BRIEF DESCRIPTION OF THE DRAWINGS

Aspects of the present invention are illustrated, merely by way of example, in the accompanying drawings in which:

FIG. 1 is a schematic plan view of the system of the present invention installed on two trees and supporting a walkway between the trees and a platform at each tree;

FIG. 2 is a schematic elevation view of the system of FIG. 2;

FIG. 3 is a detail view of the system of FIG. 1 as installed at a first tree;

FIG. 3a is a detail view showing a rubber pad adapted for fitting to an overlap point between two tension members of the woven sleeve to prevent abrasion of the tree;

FIG. 3b is a detail view taken at 3b in FIG. 3 showing the rubber pad positioned as bumper on a part of the platform to prevent abrasion of the tree by the platform;

FIG. 4 is a view of area 4-4 of FIG. 3 showing details of the interconnection between the woven tension member sleeve and a hanger assembly of the present invention that employs a ring member to organize the tension members;

FIG. 4a is a view similar to that of FIG. 4 showing an alternative interconnection arrangement without a ring;

FIG. 5 is a view of area 5-5 of FIG. 3 showing details of the interwoven cables that form the sleeve of the present invention;

FIG. 6 is a section view taken along line 6-6 of FIG. 2 showing a walkway in cross-section;

FIG. 7 is a plan view taken along line 7-7 of FIG. 3 showing a platform according to the present invention;

FIG. 8 is a detail view of an alternative arrangement for interconnecting the woven sleeve and the hanger assemblies incorporating a guide channel;

FIG. 8a is a further detail view showing the manner in which the hanger assembly and guide channel accommodate flexing of the tree;

FIG. 9 is a detail plan view showing the manner in which two different walkways are mountable to a tree using a ring member according to the system of the present invention to extend in different directions;

FIG. 9a is detail plan view of an alternative arrangement for mounting the walkways with a ring member; and

FIG. 10 is an elevation of the system of the present invention being used to support a tree.

### DESCRIPTION OF THE PREFERRED EMBODIMENTS

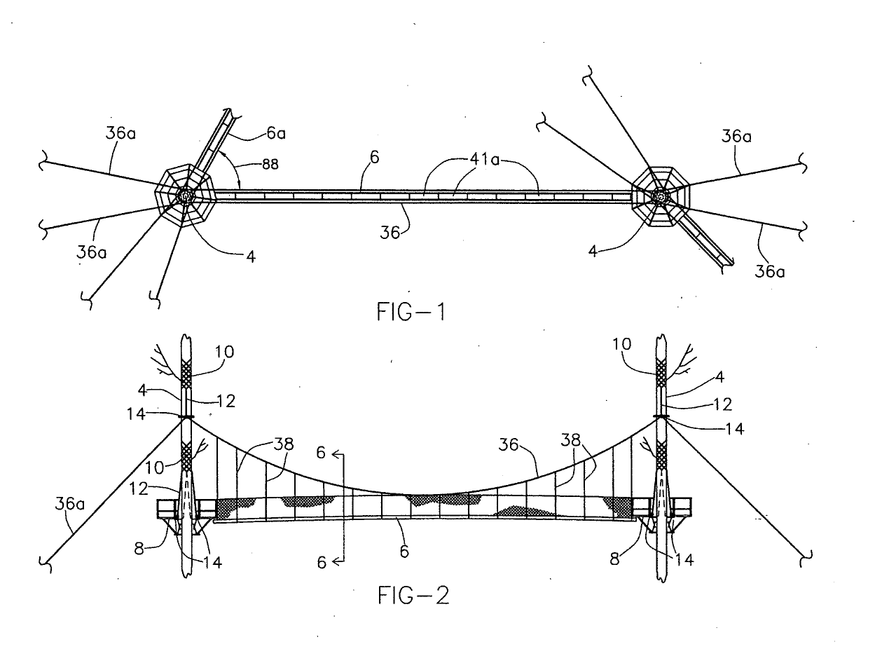

Referring to FIGS. 1 and 2, there is shown an arrangement of structures suspended from a pair of trees 4 according to a preferred embodiment of the system of the present invention. In the illustrated example shown in plan view in FIG. 1 and in elevation view in FIG. 2, an observation platform 8 extends about the trunk of each tree and a walkway 6 is suspended between the platforms. As shown in FIG. 1, an additional walkway 6a extends in a different direction to another tree (not shown). Any number of platforms 8 can be interconnected by walkways 6 to define a network of structures above the forest floor within a grouping of trees. While walkways and platforms are the structures specifically described and illustrated in the following description, it will be apparent to a person of ordinary skill in the art that other structures can be suspended using the system of the present invention.

As shown in FIG. 2, each structure 6,8 is suspended from a tree 4 using a basic suspension system in the form of a sleeve 10 adapted to grip a portion of the trunk of the tree to which are connected one or more hanger assemblies 12 having an end 14 connectable to the structure to be suspended. In a preferred embodiment, sleeve 10 comprises a collection of primary tension members interwoven to define a cylindrical sleeve adapted to encircle and grip a portion of the tree. In the illustrated arrangement, sleeves 10 are fitted about the trunk of a tree. Other locations such as major branches are also possible. Any generally cylindrical region of a tree that is of sufficient strength to support the load to be suspended can be used.

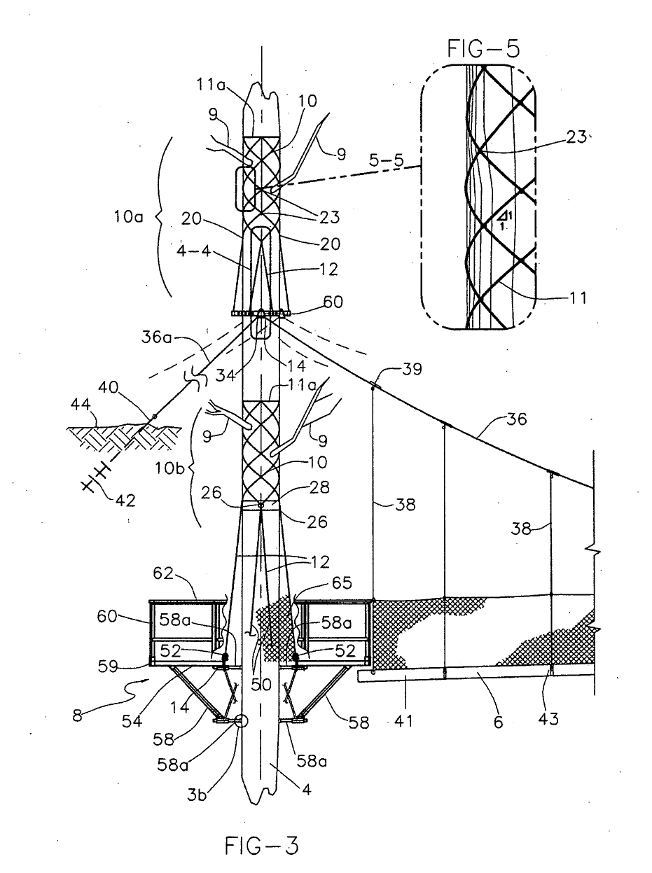

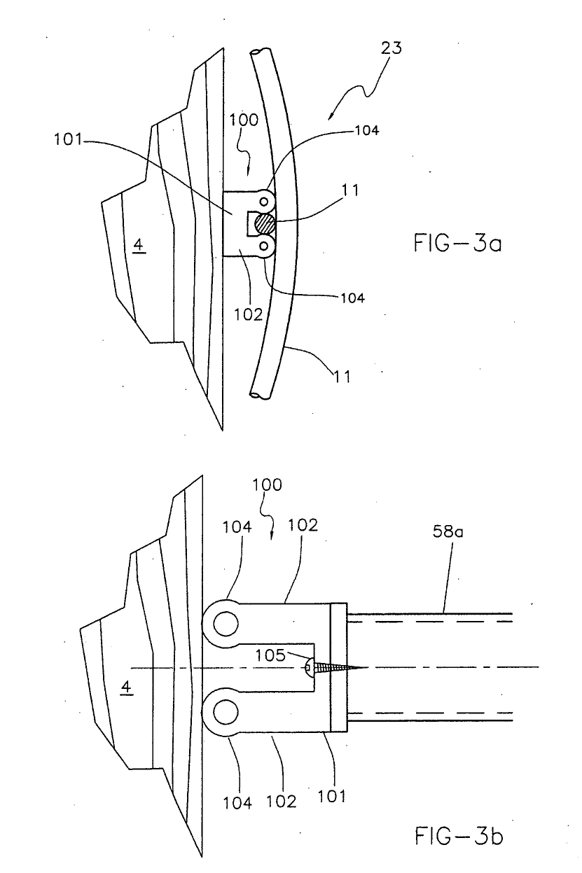

FIG. 3 is a detail view of a tree fitted with sleeves 10 according to the present invention. An upper sleeve 10a acts to support one end of walkway 6 while a lower sleeve 10b supports platform 8. Each sleeve 10 is preferably formed from a collection of primary tension members in the form of elongate, flexible steel cables 11. Flexible steel cables offer the advantages of being able to readily slide over one another at overlapping points in the woven sleeve so that load is distributed equally to prevent stress concentration points on the tree. In addition, steel cables are not affected by UV radiation and stand up well in an outdoor environment. In prototype testing, steel cables having a diameter in the range of about 3/8 inch to about 5/8 inch were found to work well. Other materials suitable for use in sleeve 10 include straps or ropes for supporting lighter loads.

FIG. 5 is a detail view showing the preferred weaving arrangement of steel cables 11 in which each cable is wound about the tree in a generally helical pattern such that the cables are at a 1:1 slope and overlap each other at points or nodes 23 at substantially right angles. In the illustrated embodiment, seven individual cables 11 are interwoven to form a sleeve 10. FIG. 3 shows the four cables at the upper end of the sleeve and the other side of the tree has three similar cables. In prototype testing, it has been determined that odd numbers of cable greater than four such as 5, 7, 9 or more cables interwoven works well to create a sleeve having a woven mesh that distributes loads to avoid pressure points on the tree and which allows the tree to breath. In such a weaving arrangement, some cables are not necessarily loaded in tension and are therefore “sleepers” load wise, but such “sleeper” cables provide sliding surfaces away from bark for overlying cables to permit relative movement of the woven cables and to accommodate grow of the tree as will be explained in more detail below. The number of cables used will depend on the weight of the structures to be supported.

As best shown in FIG. 3, openings in the weave of the cables permit passage of branches 9 through sleeve 10 so that trimming of branches is not generally necessary when fitting the sleeve. The woven structure of the sleeve also allows the sleeve to readily accommodate bends and changes in diameter of the tree. In a preferred arrangement, fitting of the woven sleeve involves installing a temporary anchor band about the tree defining an anchor point to which an upper circular end 11a of the sleeve is attached. Upper circular end 11a is preferably formed from a loop of cable selected according to the diameter of the tree. A plurality of depending cables 11 are preferably formed with eyes 22 at each end, and at the upper end of the sleeve, the loop of cable is inserted through the eyes 22 to join the cables 11 to the loop of cable. Cables 11 hanging downwardly from upper circular end 11a are then woven about the tree trunk in the above-described helical pattern. Once cables 11 are interwoven about the tree to define sleeve 10, the anchor band can be removed as the sleeve is self-supporting on the tree. The interwoven sleeve avoids slipping over a wide range of loads. The overlapping, helically interwoven cables are able to slide over each other at overlap or node points 23 to distribute load evenly to accommodate growth of the tree. When live load is removed, for example, when people walking on a supported structure step off, the cables of the sleeve will tend to recoil toward their original shape, and thus relieve the load on the tree.

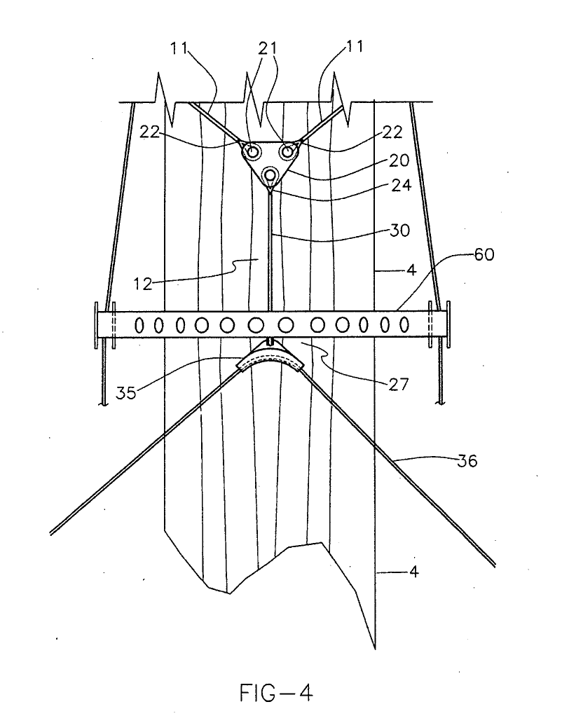

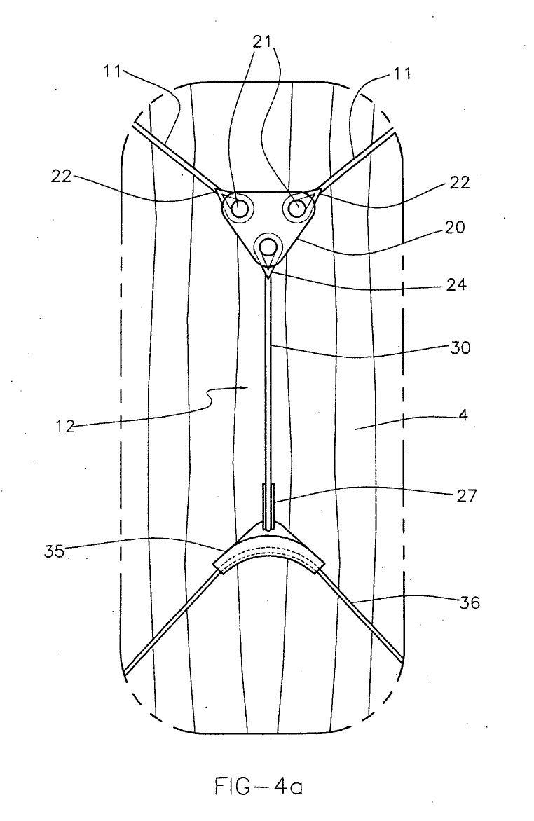

Each sleeve 10 acts as an anchor location on the tree from which structures to be suspended are hung via hanger assemblies 12. As illustrated in FIG. 3, there are preferably a plurality of hanger assemblies 12 extending from each sleeve 10. Preferably, at least two primary tension members in the form of cables 11 of woven sleeve 10 co-operate to support each hanger assembly 12. By way of example, FIG. 4 is a detail view of a hanger assembly 12 intended for use in supporting walkway 6 and shows the hanger assembly's attachment to upper sleeve 10a. An inverted generally triangular tension member collection bracket 20 joins the ends of two cables 11 from sleeve 10 by virtue of bracket pins 21 extending through eyes 22 attached to the ends of the cables. Collection bracket 20 also joins the upper end 24 of hanger assembly 12 via a pin/eye arrangement to interconnect the hanger assembly 12 and the sleeve cables 11. This arrangement tends to equalize the load of the attached hanger assembly between the connected cables 11.

Lower sleeve 10b can employ the same arrangement or, as illustrated in FIG. 3, make use of a different arrangement using collection brackets in the form of shackles 26 that are connected to pairs of sleeve cables 11 at an upper edge and to pairs of hanger assemblies 12 at a lower end. This arrangement is preferred for supporting a platform 8.

Referring back to FIG. 3, there are preferably a plurality of collection brackets 20,26 extending about the tree to join the plurality of hanger assemblies 12 to sleeves 10a,10b, respectively. As shown in association with lower sleeve 10b, the collection brackets may be attached to a belt 28 encircling the tree. Belt 28 is preferably formed from a resilient material such as rubber and acts to position the collection brackets and to protect the tree bark from abrasion by the collection brackets. While only lower sleeve 10b is shown with resilient belt 28, upper sleeve 10a may also be fitted with such a belt to position collection brackets 20 and protect the tree bark. In addition, rubber pads attached to the cables at overlap or node points 23 may be used to protect the bark from chafing and pressure concentrations. FIG. 3b shows an example of such a rubber pad 100. The pad has a generally U-shaped configuration with a base 101 that engages the tree 4 to prevent damage. Arms 102 extend outwardly from base 101. Each arm 102 preferably terminates in a hollow cylinder 104. Cylinders 104 and arms 102 are deformable to grip and receive an underlying cable 11 therebetween at an overlap or node point 23 to keep the overlapping cables from directly engaging the tree.

Hanger assemblies 12, by virtue of being suspended from woven sleeves 10, permit swaying movement of the tree due to wind while maintaining any attached structures 6,8 in their suspended configuration. Hanger assemblies 12 tend to act as movable pendulums that permit relative movement between sleeves 10 (which move with the tree) and supported structures 6, 10 which tend to remain essentially stationary.

FIG. 4 is a detail view of portion 4-4 of FIG. 3 showing a hanger assembly 12 preferably used to support a walkway 6. This hanger assembly comprises at least one secondary tension member 30 preferably in the form of a steel cable 32 having upper end 24 connected to collection bracket 20 and a lower end 27 connected to a ring member 60 extending about the circumference of the tree. Ring member 60 is suspended by a plurality of tension members 30 and acts to collect and organize all tension members in order to distribute and equalize loads amongst the members. Ring member 60 facilitates the routing of tension lines, spacing of the lines from tree trunk 4 and allows the tree freedom to move. Attached at spaced intervals about the perimeter of ring member 60 are saddle members 34 for supporting the walkway or other structure. Saddle members 34 are pivotally mounted to the ring member to accommodate some pivoting movement of the tension members. The saddle members are preferably adjustably mountable to ring member 60 about the circumference of the ring to suit the organization of incoming and outgoing tension members. For example, saddle members 34 can include a clamping element that is loosened to permit sliding movement of the saddle member about ring member 60 to a desired location whereupon the clamping element is tightened to lock the position of the saddle member on the ring member while still permitting pivoting of the saddle member ins place. Saddle member 34 is formed with an arcuate channel 35 adapted to receive and support a tertiary tension member in the form of a catenary suspension cable 36 from which one edge of a walkway 6 is suspended (FIG. 3). Preferably, on one side of saddle member 34, catenary cable 36 supports a plurality of hanger cables 38 from which one side of a walkway deck surface is suspended. On the opposite side of the saddle member, catenary cable 36 may become an anchor cable 36a that extends to an anchor location. Otherwise, catenary cable 36 extends through saddle member 34 to become the support cable for another walkway section. If the cable transitions to an anchor cable 36a after passing through saddle member 34 as shown in FIG. 3, the anchor location preferably comprises an anchor post 40 to which anchor cable 36a is connected. Anchor post 40 may includes helical threads 42 to permit driving into the ground 44 by rotation. Helical threads 42 also act to maintain the anchor post in position. The depth to which anchor post 42 is driven will depend on the weight being supported and the soil conditions. As best shown in FIG. 1, a pair of spaced, parallel catenary cables 36 are necessary to support both sides of walkway 6 with each cable extending from substantially opposite sides of a tree 4. Anchor cables 36a preferably diverge as they extend away from saddle members 34 to increase the anchored stability of the walkway.

FIG. 4a is detail view of an alternative arrangement for suspending walkways. The arrangement of FIG. 4a is identical to that of FIG. 4 except for the elimination of ring member 60. In other words, in the arrangement of FIG. 4a, each saddle member 34 is suspended directly from the lower end of tertiary tension member 30.

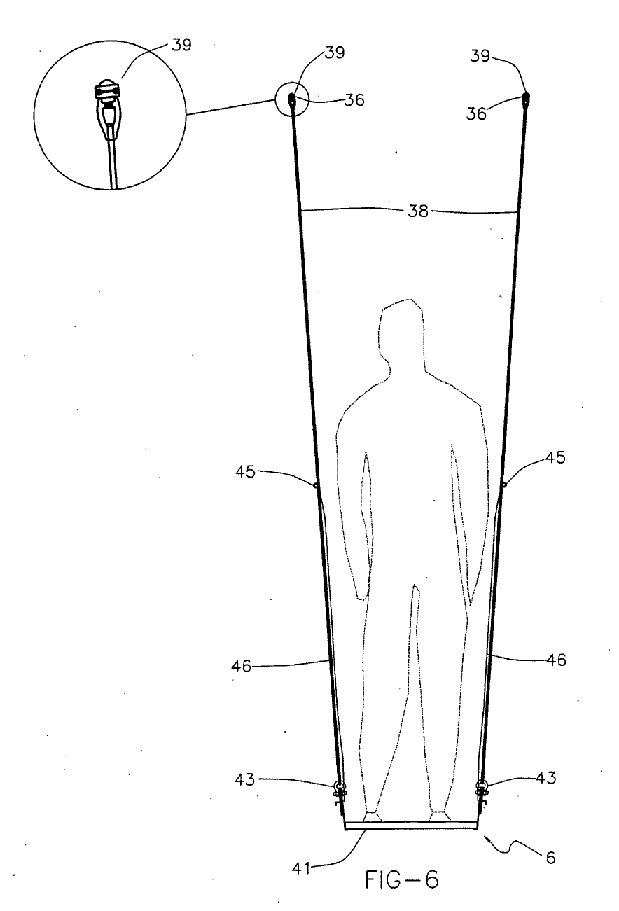

FIG. 6 provides an exemplary cross-section through walkway 6 taken along line 6-6 of FIG. 2. Hanger cables 38 extending from a pair of catenary cables 36 support opposite sides of a deck surface 41 via pin shackles 43. Hanger cables are attached to catenary cables by clamps 39. As best shown in FIG. 1, deck surface 41 is preferably formed from modular sections 41a connectable together to define a contiguous deck surface. Each deck section may be formed from aluminium components for reduced weight with pin shackles 43 attached to hanger cables 38 supporting each section end. A rope or cable extending between hanger cables defines a hand rail 45 with safety netting 46 extending from the hand rail to the decking to prevent falls.

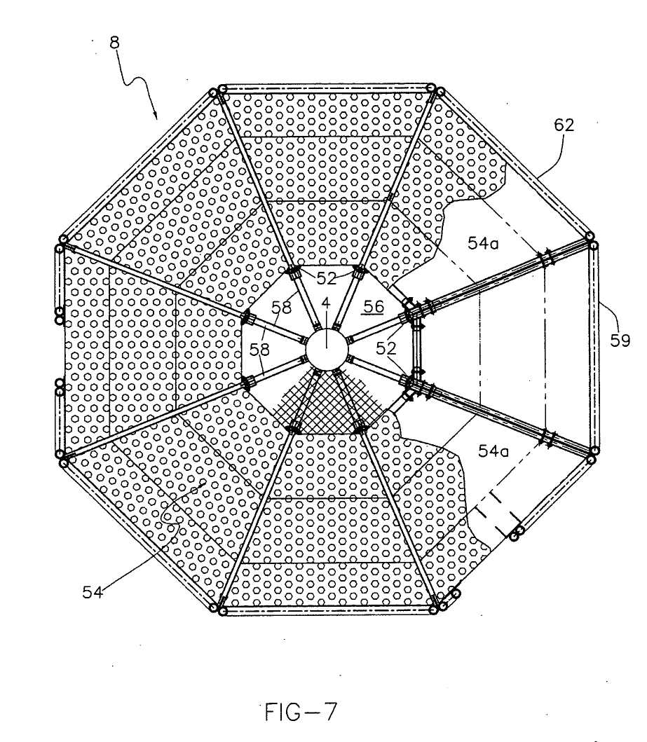

Referring back to FIG. 3, an alternative hanger assembly 12 may be used to suspend platform 8 from lower sleeve 10b. In this case, each hanger assembly comprises a tertiary tension member 50 connected to shackle 26 at an upper end and to shackle 52 at a lower end. Shackle 52 is mounted to a support sub frame 58 of platform 8. FIG. 7, taken along line 7-7 of FIG. 3, shows platform 8 in plan view. Platform 8 preferably comprises a generally annular floor surface 54 having a central opening 56 to accommodate tree 4. Radially aligned sub frame members 58 support floor surface 54. Platform 8 is preferably modular and comprises a plurality of sub frame members 58 supporting a plurality of generally trapezoidal floor surface segments 54a to facilitate field assembly. Floor surface segments 54a are lowerable into place and fastened to lower sub frame members 58. The sub frame members are modular and can be split into separate pieces to facilitate maneuvering around branches, then installed in place. The inside edge (nearest the tree trunk) of each floor surface segment 54a or a side edge are preferably hingedly mounted to the underlying sub frame member 58 so each segment can be pivoted upwardly out of the plane of the floor surface to create an opening in the floor to permit climbing through.

As best shown in FIG. 3, sub frame members 58 beneath floor surface 54 are preferably formed from bracing members arranged in a triangular truss configuration for strength and weight considerations. Extending inwardly from each sub frame member are telescopic bracing arm 58a extendable to abut the tree to centre the tree within opening 56. The telescopic bracing arms 58a are aligned to extend generally horizontally adjacent the top and bottom of the each sub frame member 58 into space 56 to abut tree trunk 4. Each bracing arm preferably includes a flexible, rubber cushioning end to engage the tree trunk to minimize damage to the trunk. As best shown in FIG. 3b, this cushioning function can be performed by the same rubber pad 100 that is used at node points 23. The rubber pad 100 is mounted to the end of bracing arm 58a by a fastener 105 extending through base 101. Deformable hollow cylinder 104 and arms 102 acts to absorb loads to minimize damage to the tree. The sub frame member and bracing arms act to distribute and equalize unbalanced loads on the platform to the tree trunk. For example, an unbalanced load will result when several people move as a group to one side of the platform. The outer edge 59 of the assembled platform has attached, upstanding posts 60 and top rail 62 to define a safety barrier. Safety netting 65 extends between the inner edge 65 of the platform and tree 4 to prevent users falling through hole 56. The floor surface, sub frame members and safety barrier of the platform are preferably made from aluminium components to minimize loading.

FIG. 3 also shows that the ends of walkways 6 are supported by hanger cables 38 and are not directly connected to suspended platforms 8. This arrangement allows for independent movement of the platforms and the walkways to accommodate movement of trees acting as the primary support structures for the system of the present invention. The tree enjoys the maximum degree of freedom of movement by virtue of attached platform 8 and walkway 6 being unconnected and free to move separately.

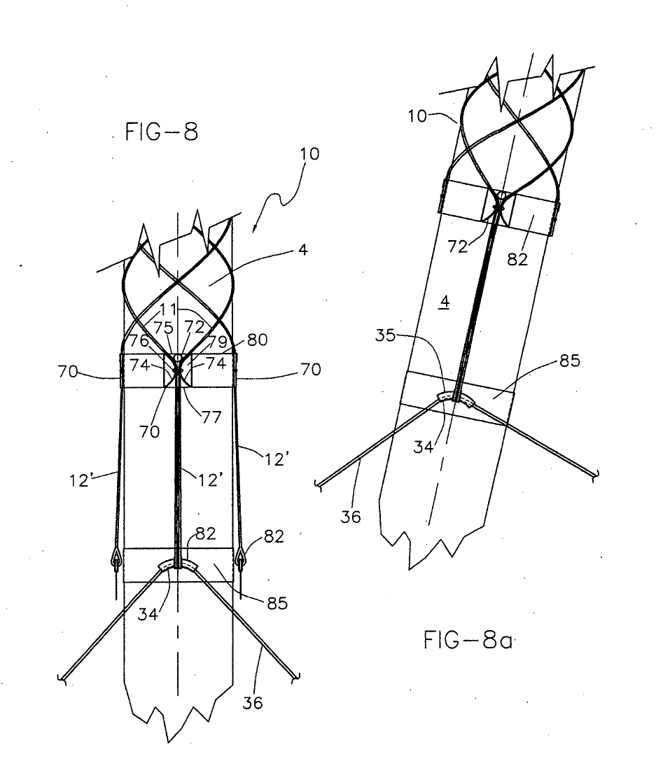

FIG. 8 illustrates an alternative arrangement for connecting hanger assemblies to woven sleeve 10 adapted accommodate swaying movement of tree 4. This arrangement is best suited for suspending walkways 6 and relies on saddle members 34 to support catenary cables 36 of the walkway. In this alternative arrangement, each hanger assembly 12′ connecting saddle members 34 to woven sleeve 10 is formed from the ends of the primary tension members that make up the sleeve. In this case, hanger assemblies 12′ are formed from the ends of at least two cables 11 that are fed through a specially adapted collection bracket 70. Collection bracket 70 is formed with a collection channel 72 through which each of the at least two cables 11 extend. Collection channel 72 is defined by a pair of spaced, opposed curved section 74 oriented such that the collection channel has a tapering inlet 75, a constricted intermediate section 76 and an expanding outlet 77. Curved sections 74 are mounted to a base plate 79 which is affixed to a resilient belt 80 encircling tree 4 to position the collection brackets 70 adjacent the lower end of sleeve 10. The ends of a pair of cables 11 fed through channel 72 are maintained immediately adjacent each other by constricted intermediate section 76. Cables 11 terminate in eyelets 82 in which saddle member 34 is held. As best shown in FIG. 8a, when tree 4 moves off a generally vertical orientation due to swaying, channel 72 tends to guide and constrain movement of cables 11 such that movement of saddle member 34 is minimized. In addition, any movement of saddle member 34 tends to be limited to a gentle rocking motion beneath catenary cable 36. Cable 36 remains supported in arcuate channel 35 so that the cable maintains its operating configuration supporting walkway 6. A resilient belt 85 preferably encircles tree 4 adjacent saddle member 34 to protect the tree from movement of the fittings. Belts 82 and 85 do not have to fully encircling, but can comprise pads affixed to the tree below each of the fittings.

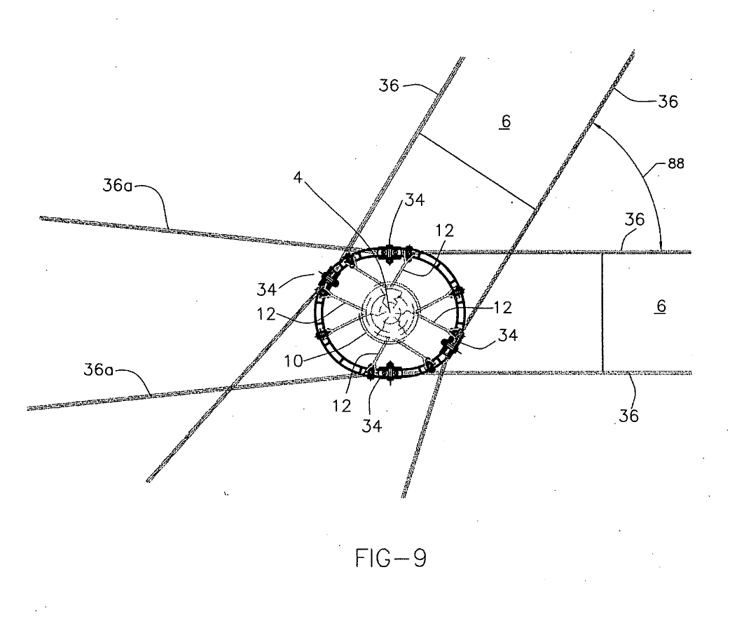

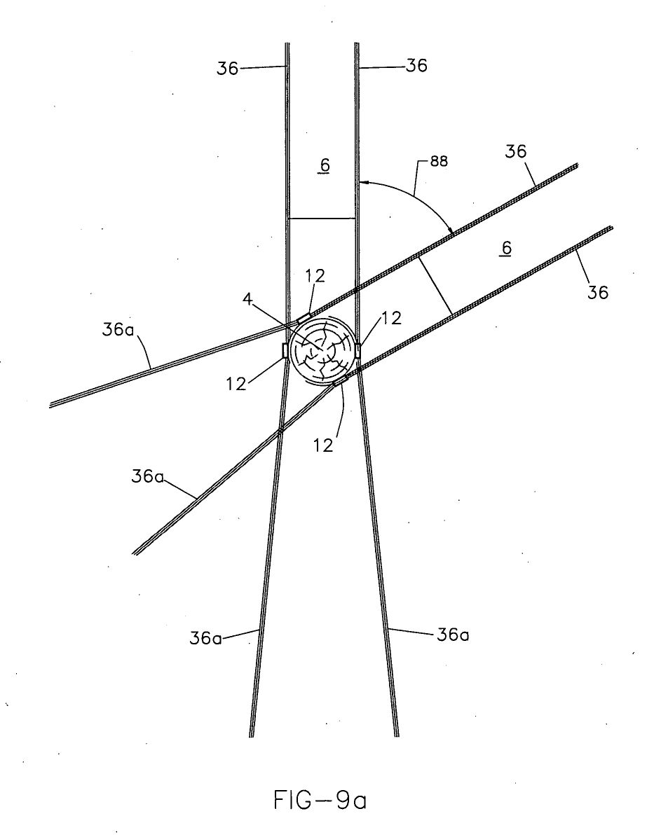

FIG. 9 is a plan view of a tree 4 fitted with a sleeve 10 according to the embodiment of the present invention that makes use of ring member 60 (see FIG. 4). FIG. 9 shows the manner in which sleeve 10, which is in close contact with the tree, supports ring member 60 via a plurality of equally spaced hanger assemblies 12 to. Mounted to ring member 60 are pairs of saddle members 34 on opposite sides of the tree to support spaced pairs of catenary cables 36 (and anchor cables 36a) that define walkways 6 extending in any desired direction including multiple walkways extending from the same tree at an angle 88 to each other. Note that saddle members 34 do not have to be equally spaced about ring member 60, rather they are positioned to best receive cables 36.

FIG. 9a is a plan view of a tree 4 fitted with a sleeve 10 according to the embodiment of the present invention that does not use ring member 60 (see FIG. 4a). In this arrangement, pairs of hanger assemblies 12 extending from sleeve 10 on opposite sides of tree 4 support spaced pairs of catenary cables 36 (and anchor cables 36a) that define walkways 6 extending in any desired direction including multiple walkways extending from the same tree at an angle 88 to each other. In this arrangement without ring member to position saddle member, each hanger assembly 12 must directly support a saddle member 34. Hanger assemblies 12 are flexible and sleeve 10 can be distorted slightly about the tree trunk to permit appropriate positioning of the saddle members about the circumference of the tree to support a walkway extending in any desired direction. In other words, hanger assemblies do not need to be positioned equidistantly about the circumference of a tree.

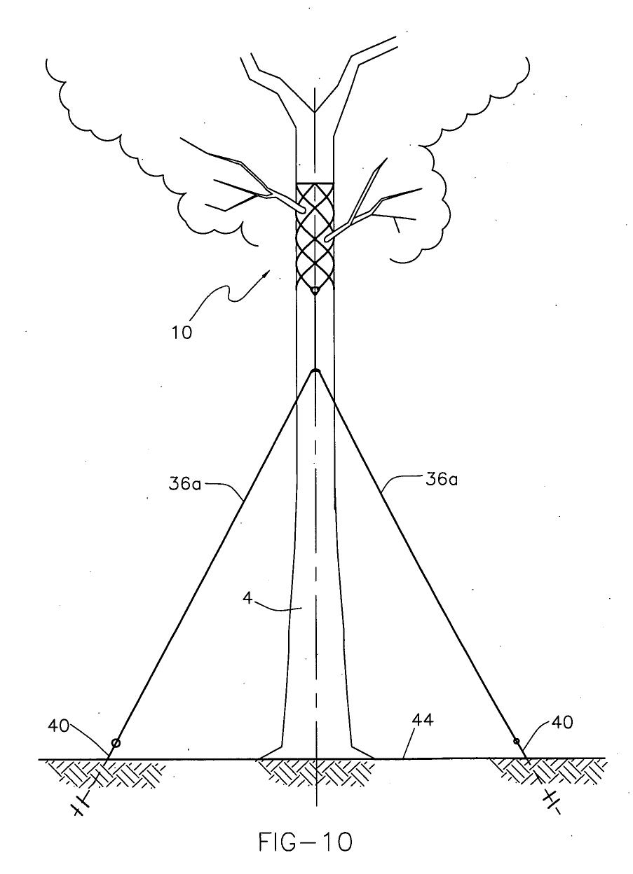

While the foregoing description has concentrated on describing a system for supporting structures such as platforms or walkways from or between trees, it will be appreciated that the woven sleeve and tension cable system of the present invention can support a wide range of articles from a tree and is not limited to the structures specifically illustrated and described. The woven sleeve also finds application in various Forestry functions where it is necessary to fasten articles to a tree and apply load to the tree without damaging the branches or trunk of the tree. As illustrated in FIG. 10, the woven sleeve 10 of the present invention can also be used to provide support for damaged or weak trees 4. A woven sleeve 10 is fitted about the trunk of the damaged or weakened tree and connected directly to anchor cables 36a that are engaged in the ground via anchor posts 40 in order to brace and steady the tree. Alternatively anchor cables 36a can extend to a fixed, anchor surface to support the tree.

Although the present invention has been described in some detail by way of example for purposes of clarity and understanding, it will be apparent that certain changes and modifications may be practised within the scope of the appended claims.

1. A system for suspending a structure from a tree comprising:
a collection of primary tension members interwoven to define a sleeve adapted to grip a portion of the tree; and
at least one hanger assembly extending from the sleeve for supporting the structure to be suspended.

2. A system as claimed in claim 1 in which the collection of primary tension members is formed from elongate steel cables.

3. A system as claimed in claim 1 in which the collection of primary tension members is woven into a generally cylindrical sleeve in which elongate tension members extend in a generally helical pattern.

4. A system as claimed in claim 3 in which the primary tension members overlap each other at substantially right angles.

5. A system as claimed in claim 4 in which the sleeve is woven from an odd number of tension members greater than four in number.

6. A system as claimed in claim 1 in which a plurality of hanger assemblies extend from the collection of primary tension members and wherein at least two primary tension members co-operate to support each hanger assembly.

7. A system as claimed in claim 6 including a tension member collection bracket to which each of the at least two primary tension members are joined to support each hanger assembly.

8. A system as claimed in claim 7 in which there are a plurality of tension member collection brackets which are attached to a belt adapted to encircle the tree.

9. A system as claimed in claim 8 in which the belt is resilient.

10. A system as claimed in claim 7 in which each hanger assembly comprises at least one secondary tension member having a first end connected to the tension member collection bracket and a second end with a connector for supporting the structure to be suspended.

11. A system as claimed in claim 10 in which the connector comprises a saddle member adapted to support a tertiary tension member extending from the structure to be suspended.

12. A system as claimed in claim 7 in which each hanger assembly comprises at least one secondary tension member having a first end connected to the tension member collection bracket and a second end connected to a rigid ring member for mounting at least one connector for supporting the structure to be suspended.

13. A system as claimed in claim 12 in which the at least one connector is releasably lockable to the ring member for positioning at a desired location about the ring member.

14. A system as claimed in claim 13 in which the at least one connector comprises a saddle member mounted for pivotal movement with respect to the ring member and adapted to support a tertiary tension member connectable to the structure to be suspended.

15. A system as claimed in claim 1 in which the structure to be suspended comprises a walkway supported by suspension cables with hanger assemblies joining the suspension cables to the sleeve.

16. A system as claimed in claim 15 in which the suspension cable has ends which are anchorable into the ground.

17. A system as claimed in claim 15 in which the walkway is suspended from at least a pair of suspension cables by a plurality of hanger cables extending between the suspension cables and a walkway deck surface.

18. A system as claimed in claim 17 in which the walkway deck surface is formed from modular sections connectable together to define a contiguous deck surface.

19. A system as claimed in claim 1 in which the structure to be suspended comprises a suspendable platform positionable about the trunk of the tree with hanger assemblies connecting the suspendable platform to the sleeve.

20. A system as claimed in claim 19 in which the suspendable platform comprises an annular surface having a central opening to accommodate the trunk of the tree and a plurality of radially extending bracing members extendable to abut the tree.

21. A system as claimed in claim 19 in which the suspendable platform is modular and comprises at least one platform section having a bracing member extendable to abut the tree and space the platform radially apart from the tree.

22. A system as claimed in claim 1 in which a plurality of hanger assemblies are formed from the collection of primary tension members and wherein at least two primary tension members co-operate to define each hanger assembly.

23. A system as claimed in claim 22 including a tension member collection bracket having a collection channel through which each of the at least two primary tension members extend to control movement of the tension members in the event of movement of the tree.

24. A system as claimed in claim 23 in which the tension member collection bracket comprises a pair of spaced members defining the collection channel therebetween to retain the at least two primary tension members.

25. A system as claimed in claim 24 in which the spaced members are formed as opposed curved sections oriented such that the collection channel has a tapering inlet, a constricted intermediate section and an expanding outlet.

26. A system as claimed in claim 22 in which each hanger assembly has a second end with a connector for supporting the structure to be suspended.

27. A system as claimed in claim 26 in which the connector comprises a saddle member adapted to support a tertiary tension member extending from the structure to be suspended.

28. A system as claimed in claim 27 in which the structure to be suspended comprises a walkway and the tertiary tension member comprises a suspension cable for the walkway.

29. A system as claimed in claim 28 in which the suspension cable has ends which are anchorable into the ground.

30. A system as claimed in claim 28 in which the walkway is suspended from at least a pair of suspension cables by a plurality of hanger cables extending between the suspension cables and a walkway deck surface.

31. A system as claimed in claim 30 in which the walkway deck surface is formed from modular sections connectable together to define a contiguous deck surface.

32. A tree structure comprising:
a tree having a region to act as an anchor;
at least one array of primary tension members interwoven to define a sleeve adapted to surround and engage the region of the tree;
hanger assemblies extending from the sleeve; and
at least one platform structure supported by the hanger assemblies.

33. A system for supporting a tree comprising:
a collection of primary tension members interwoven to define a sleeve adapted to grip a portion of the tree; and
at least one anchor line extending from the sleeve having an end for attachment to a fixed anchor surface in order to brace and support the tree.
